(19) United States
(12) Patent Application Publication
(10) Pub. No.: US 2007/0136993 A1
(43) Pub. Date: Jun. 21, 2007

(54) Automobile door hinge device

(75) Inventors: Yoshio Ishii, Saitama (JP); Manabu Ochiai, Saitama (JP)

Correspondence Address: ARENT FOX PLLC, 1050 CONNECTICUT AVENUE, N.W., SUITE 400, WASHINGTON, DC, 20036, US

(73) Assignee: RIKENKAKI KOGYO KABUSHIKI

(21) Appl. No.: 11/602,468

(22) Filed: Nov. 21, 2006

(30) Foreign Application Priority Data
Nov. 24, 2005 (JP) 2005-338500

(51) Int. Cl. E05D 11/10

(52) U.S. Cl. 16/334

(57) ABSTRACT

An automobile door hinge device includes: an inner cylindrical body integrally connected to a first bracket and rotatably fitted over an outer periphery of a hinge pin; an outer cylindrical body integrally connected to a second bracket to surround the inner cylindrical body; a check spring disposed between the inner cylindrical body and the outer cylindrical body to come into contact with an outer peripheral surface of the inner cylindrical body with a resilient force of the check spring; and first and second control portions that are provided in the inner cylindrical body to face first and second engaging portions, respectively, at opposite ends of the check spring, and displace the first and second engaging portions in directions releasing the contact of the check spring during relative rotation of the inner cylindrical body and the outer cylindrical body. Thus, the door hinge can exert a stepless door check function of holding a door at any opening degree.

### RELATED APPLICATION DATA

The present invention is based upon Japanese priority application No. 2005-338500, which is hereby incorporated in its entirety herein by reference.

### BACKGROUND OF THE INVENTION

1. Field of the Invention

The present invention relates to an automobile door hinge device including a first bracket secured to one of a body and a door, a second bracket secured to the other thereof, and a hinge pin that relatively rotatably connects the brackets. The present invention particularly relates to a door hinge device that allows any check position of the door, that is, that can hold the door at any opening degree position.

2. Description of the Related Art

Conventional automobiles generally include a door hinge for connecting a door to a body, and also a door checker for holding the door at predetermined opening degree positions. As disclosed in Japanese Patent Publication No. 3-13392, the door checker generally includes: a case secured to a door; a check plate that is supported by a body and movably passes through the case; a shoe holder that is held by the case and moves toward and away from the check plate; a shoe that is held by the shoe holder and slides on the check plate with relative movement of the case and the check plate; and a check spring that resiliently urges the shoe holder toward the check plate within the case so that the shoe comes into contact with the check plate, the check plate having a detent notch engaging the shoe, and the door being stopped and held at defined opening degrees by an engaging force between the detent notch and the shoe.

### SUMMARY OF THE INVENTION

In the conventional door checker, the opening degree of the door held is moderately defined, and thus the door cannot be stopped and held at a position other than those of the defined opening degrees. The door checker is mounted in line with the door hinge, between the body and the door, which increases the number of components and the number of assembling steps, thereby limiting reduction in the cost and providing an undesirable appearance.

The present invention has been achieved in view of such circumstances, and has an object to provide an automobile door hinge device in which a door hinge can exert a stepless door check function of holding a door at any opening degree.

In order to achieve the above object, according to a first feature of the present invention, there is provided an automobile door hinge device comprising: a first bracket secured to one of a body and a door; a second bracket secured to the other thereof; and a hinge pin that relatively rotatably connects the brackets to each other, wherein the device further comprises: an inner cylindrical body integrally connected to the first bracket and rotatably fitted over an outer periphery of the hinge pin; an outer cylindrical body integrally connected to the second bracket to surround the inner cylindrical body; a check spring disposed between the inner cylindrical body and the outer cylindrical body to come into contact with an outer peripheral surface of the inner cylindrical body or an inner peripheral surface of the outer cylindrical body with a resilient force of the check spring; a first control portion that is provided in one of the inner cylindrical body and the outer cylindrical body to face a first engaging portion at one end of the check spring, and displaces the first engaging portion in a direction releasing the contact of the check spring during relative rotation in one direction of the inner cylindrical body and the outer cylindrical body; and a second control portion that is provided in said one of the inner cylindrical body and the outer cylindrical body to face a second engaging portion at the other end of the check spring, and displaces the second engaging portion in a direction releasing the contact of the check spring during the relative rotation in the other direction of the inner cylindrical body and the outer cylindrical body.

With the first feature of the present invention, the inner cylindrical body, the outer cylindrical body, and the check spring are incorporated into the door hinge which includes the female bracket and the male bracket connected together by the hinge pin to provide a door check function to the door hinge. This can provide a door hinge device with a reduced number of components, thus reducing the number of assembling steps and the cost, and improving the appearance. Further, the door check function allows the door to be held at any opening degree, thus always preventing voluntary movement of the door.

According to a second feature of the present invention, in addition to the thirst feature, the check spring is adapted to come into contact with the inner peripheral surface of the outer cylindrical body, and the first and second control portions are provided in the inner cylindrical body.

With the second feature of the present invention, an expanding resilient force of the check spring generates a large friction force between the check spring and the outer cylindrical body, thereby holding the door at any opening degree position.

According to a third feature of the present invention, in addition to the thirst feature, the check spring is adapted to come into contact with the outer peripheral surface of the inner cylindrical body, and the first and second control portions are provided in the outer cylindrical body.

With the third feature of the present invention, a contracting resilient force of the check spring generates a large friction force between the check spring and the inner cylindrical body, thereby holding the door at any opening degree position.

According to a fourth feature of the present invention, in addition to any of the first to third features, the check spring comprises a coil spring.

With the fourth feature of the present invention, the check spring comprises the coil spring, thereby reliably bringing the entire peripheral surface of the check spring into contact with the inner peripheral surface of the outer cylindrical body or the outer peripheral surface of the inner cylindrical body, and always stabilizing a force for holding the door.

The above-mentioned object, other objects, characteristics, and advantages of the present invention will become apparent from preferred embodiments, which will be described in detail below by reference to the attached drawings.

### BRIEF DESCRIPTION OF THE DRAWINGS

FIG. 1 is a perspective view of essential portions of an automobile including a door hinge device according to a first embodiment of the present invention.

FIG. 2 is an enlarged view of a portion 2 in FIG. 1.

FIG. 3 is an enlarged sectional view taken along the line 3-3 in FIG. 2.

FIG. 4 is a sectional view taken along the line 4-4 in FIG. 3 (showing a fully closed state of a door).

FIG. 5 is a sectional view taken along the line 5-5 in FIG. 4.

FIG. 6 is an exploded perspective view of the door hinge device.

FIG. 7 is a view corresponding to FIG. 4 showing an intermediate opening degree holding state of the door.

FIG. 8 is a view corresponding to FIG. 4 showing a fully opened state of the door.

FIG. 9 is a view corresponding to FIG. 4 showing a second embodiment of the present invention (showing a fully closed state of a door).

FIG. 10 is a view corresponding to FIG. 9 showing an intermediate opening degree holding state of the door.

FIG. 11 is a view corresponding to FIG. 9 showing a fully opened state of the door.

FIG. 12 is a perspective view of a modification of a check spring in the first embodiment.

FIG. 13 is a perspective view of a modification of a check spring in the second embodiment.

### DETAILED DESCRIPTION OF THE PREFERRED EMBODIMENTS

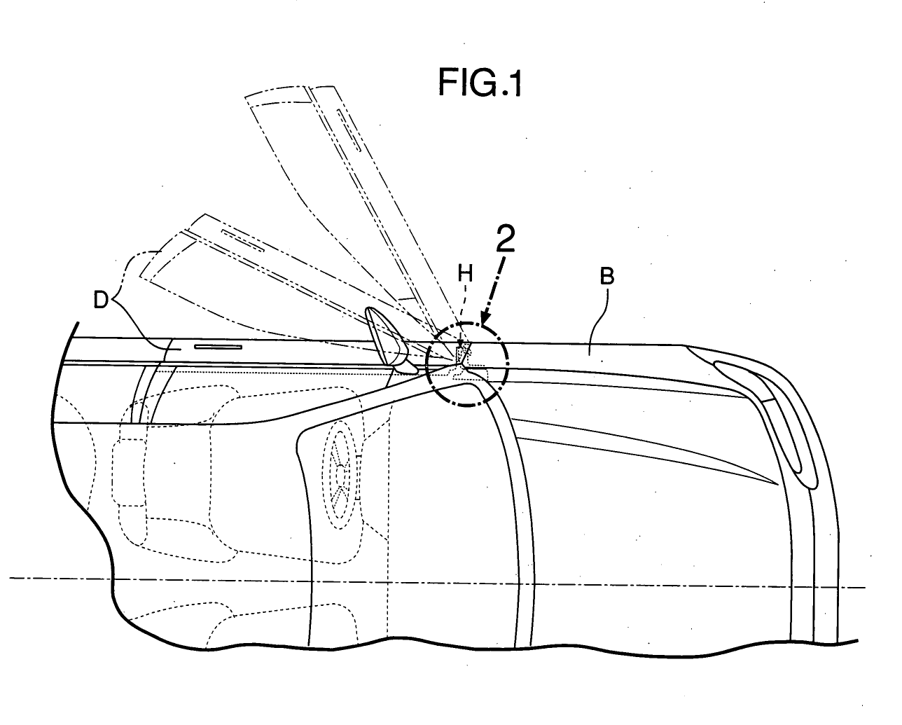

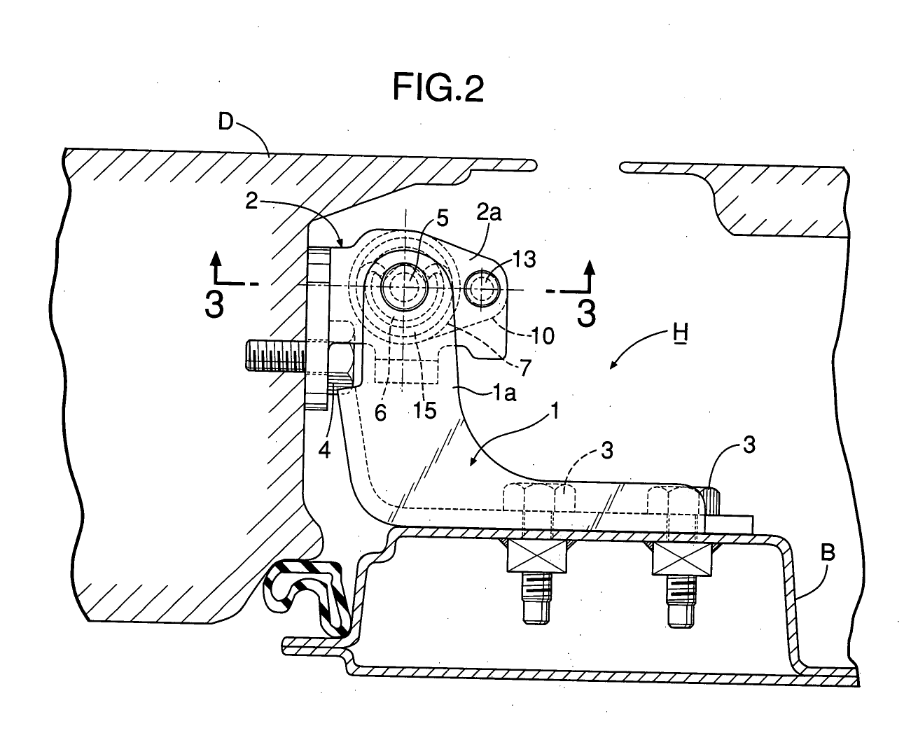

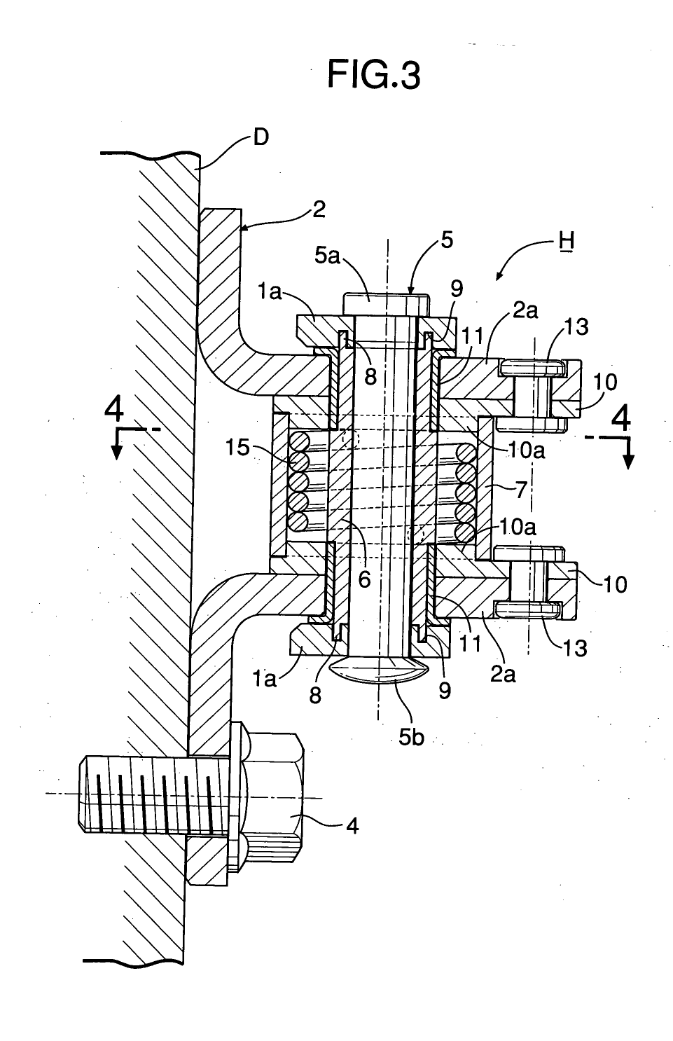

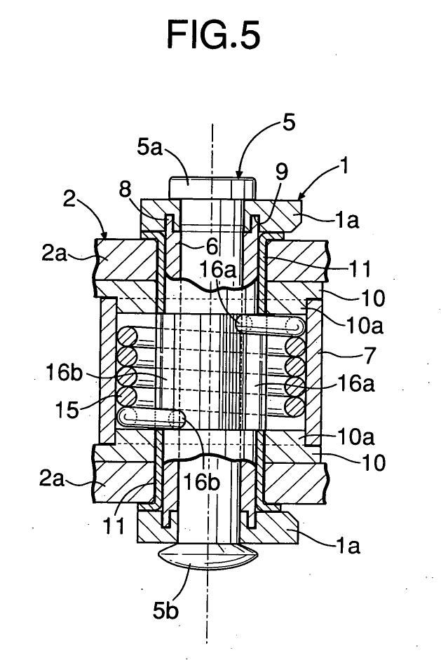

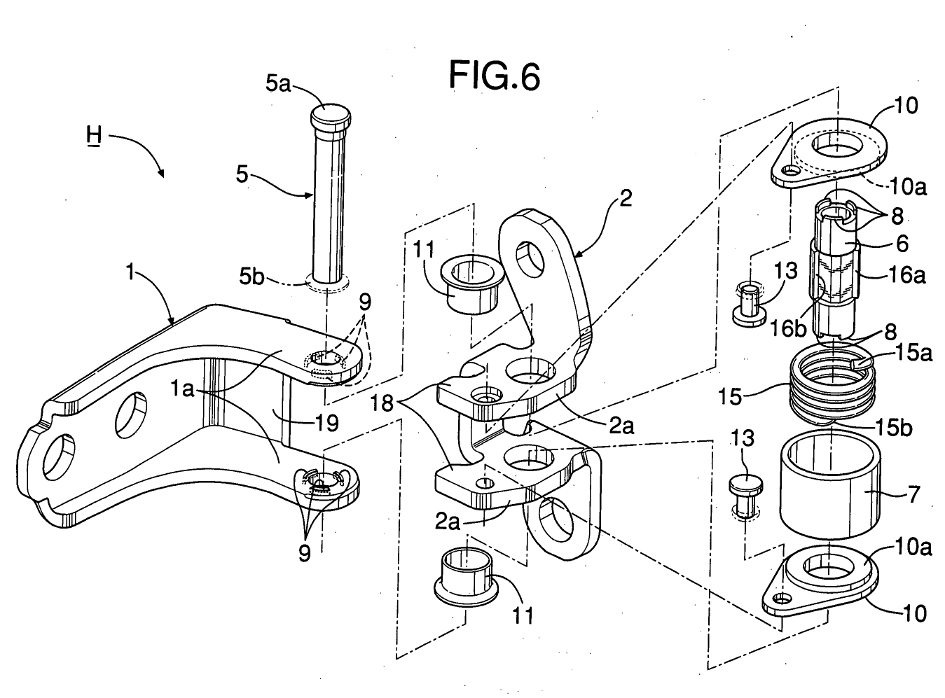

A first embodiment of the present invention shown in FIGS. 1 to 8 will be described. In FIGS. 1 and 2, a door D is rotatably mounted to a body B of an automobile via a pair of upper and lower door hinges H (one of them is shown in the figures) so as to open and close an ingress/egress opening of the automobile. Each door hinge H includes: a female bracket 1 secured to the body B by a plurality of bolts 3; a male bracket 2 secured to the door D by a plurality of bolts 4; and a hinge pin 5 vertically disposed so as to relatively rotatably connect the brackets 1 and 2 to each other.

As shown in FIGS. 2 to 6, the following arrangement is further provided to one or both of the pair of door hinges H.

A pair of upper and lower male arm portions 2a of the male bracket 2 are disposed inside and adjacent to a pair of upper and lower female arm portions 1a of the female bracket 1, and the hinge pin 5 is arranged so as to vertically pass through the arms. An inner cylindrical body 6 that passes through the female arm portions 1a is relatively rotatably fitted over an outer periphery of the hinge pin 5. Opposite ends of the inner cylindrical body 6 are integrally connected to the female arm portions 1a by engagement between a plurality of protrusions 8 and recesses 9 provided in opposed surfaces thereof. Such a connected state is held by a head 5a and a crimping end 5b of the hinge pin 5.

A pair of lid plates 10 through which the inner cylindrical body 6 passes are secured to inner surfaces of the pair of male arm portions 2a by rivets 13. A common bearing bush 11 that rotatably supports the inner cylindrical body 6 is mounted to each male arm portion 2a and the lid plate 10 secured to each other.

Circular connection bosses 10a concentric with the inner cylindrical body 6 are integrally formed on opposed surfaces of the pair of lid plates 10. Opposite ends of the outer cylindrical body 7 are pressed-fitted into and secured to outer peripheral surfaces of the connection bosses 10a. Thus, the outer cylindrical body 7 is disposed to concentrically surround the inner cylindrical body 6. A check spring 15 is housed in the outer cylindrical body 7. The check spring 15 comprises a coil spring, and has an outer diameter larger than an inner diameter of the outer cylindrical body 7 in a free state. The check spring 15 is radially compressed and inserted into the outer cylindrical body 7, and then the compressing force is released, thus bringing the check spring 15 into contact with the inner peripheral surface of the outer cylindrical body 7 with an expanding resilient force of the check spring 15.

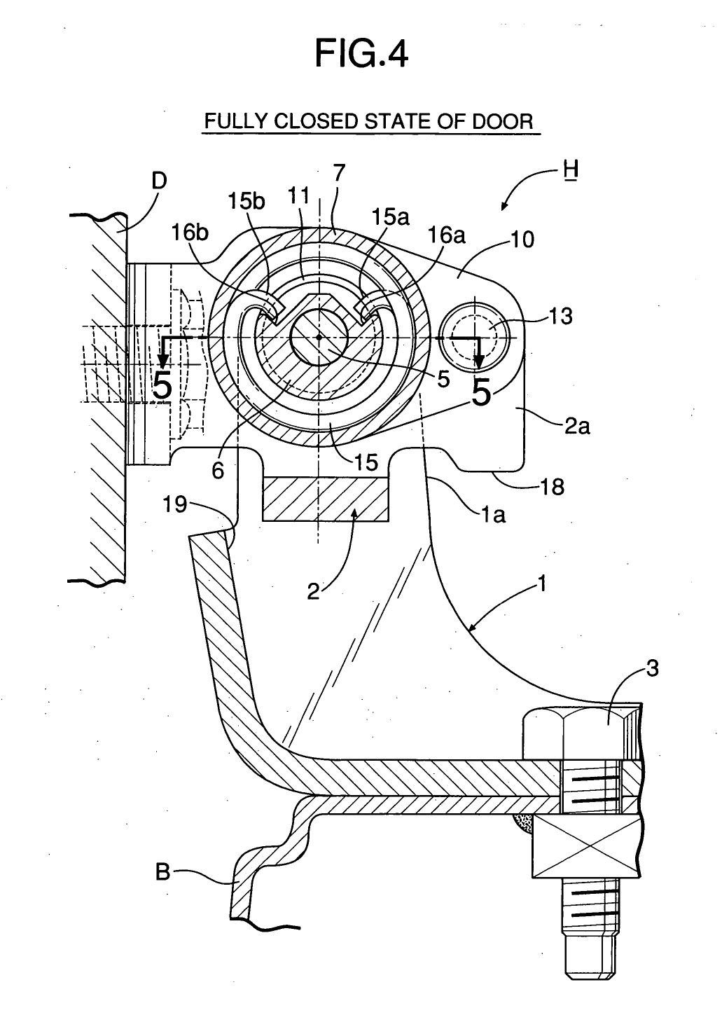

As shown in FIGS. 4 to 6, opposite ends of the check spring 15 have first and second engaging portions 15a and 15b formed by bending wire ends of the spring radially inwardly. First and second control portions 16a and 16b are formed in an outer periphery of the inner cylindrical body 6 so that they face inner surfaces of the first and second engaging portions 15a and 15b, respectively, with minute clearances therebetween in a circumferential direction of the check spring 15.

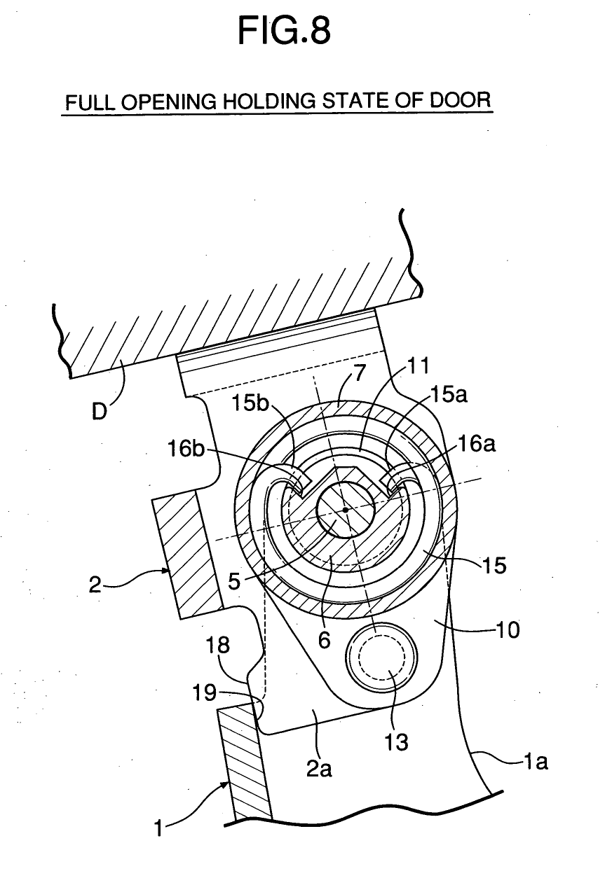

As shown in FIGS. 4 and 8, the female bracket 1 and the male bracket 2 have a fixed stopper portion 19 and a movable stopper portion 18, respectively, that abuttably face each other. The stopper portions abut against each other to restrict a fully opened position of the door D.

Next, an operation of the first embodiment will be described.

The inner cylindrical body 6 is integrally connected to the female bracket 1 secured to the body B. The outer cylindrical body 7 is integrally connected to the male bracket 2 secured to the door D. Thus, the inner cylindrical body 6 and the outer cylindrical body 7 are relatively rotated with opening and closing of the door D.

On the other hand, the check spring 15 arranged in the outer cylindrical body 7 is generally in contact with the inner peripheral surface of the outer cylindrical body 7 with its own expanding resilient force. Thus, a large friction force that resists relative rotation between the outer cylindrical body 7 and the check spring 15 is generated therebetween. The first and second control portions 16a and 16b of the inner cylindrical body 6 face the first and second engaging portions 15a and 15b so as to prevent rotation of the check spring 15.

Thus, for example, as shown in FIGS. 4, 7 and 8, when the door D is at any opening degree position in an unloaded state, the door D can be held at any desired stop position by the large friction force between the check spring 15 and the outer cylindrical body 7.

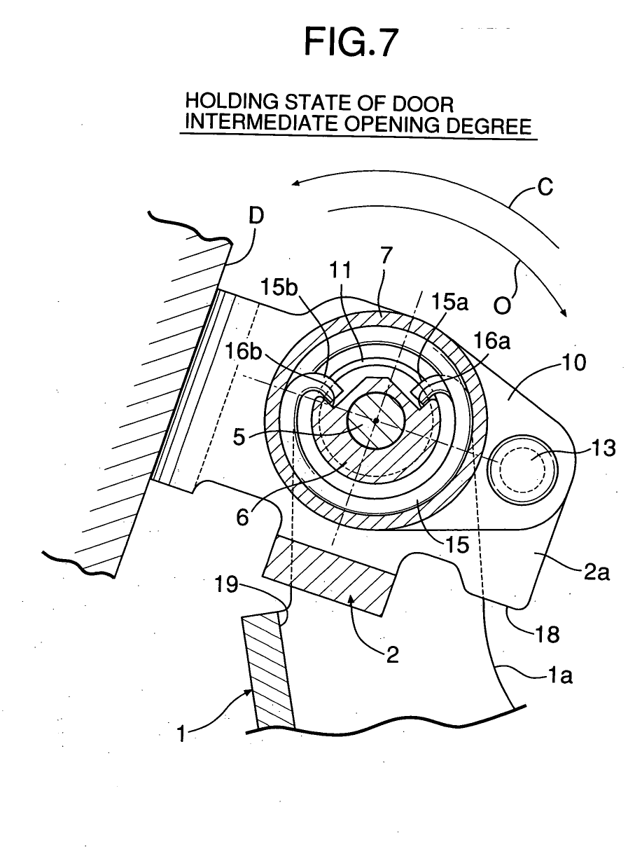

As shown in FIG. 7, for example, if an opening operation force O of a predetermined value or more is applied to the door D held at any intermediate opening degree position, the first control portion 16a of the inner cylindrical body 6 relatively pushes the first engaging portion 15a of the check spring 15 to squeeze the check spring 15, thus radially compressing the check spring 15 to reduce the friction force between the check spring 15 and the outer cylindrical body 7. Therefore, the door D can be smoothly opened while causing a slide between the outer cylindrical body 7 and the check spring 15.

If a closing operation force C of a predetermined value or more is applied to the door D, the second control portion 16b of the inner cylindrical body 6 pushes the second engaging portion 15b of the check spring 15 to similarly squeeze the check spring 15, thus radially compressing the check spring 15 to reduce the friction force between the check spring 15 and the outer cylindrical body 7. Therefore, the door D can be smoothly closed while causing a slide between the outer cylindrical body 7 and the check spring 15.

As described above, if the door D is rotated in an opening direction or a closing direction to release the opening operation force O or the closing operation force C applied to the door D at any opening degree position, the door D again enters the unloaded state, whereby the door D can be held at any stop position by the large friction force generated between the check spring 15 and the outer cylindrical body 7 as described above.

As described above, the inner cylindrical body 6, the outer cylindrical body 7, and the check spring 15 are incorporated into the door hinge H which includes the female bracket 1 and the male bracket 2 connected together by the hinge pin 5, thereby providing a door check function to the door hinge H. This can provide a door hinge device with a reduced number of components, thus reducing the number of assembling steps and the cost, and improving the appearance. Further, the door check function allows the door to be held at any opening degree, thus always preventing any voluntary movement of the door.

Opening surfaces at the opposite ends of the outer cylindrical body 7 that houses the check spring 15 are closed by the pair of lid plates 10, thereby further improving an appearance, preventing dust from entering the outer cylindrical body 7, and stabilizing friction force characteristics between the check spring 15 and the outer cylindrical body 7.

Further, the check spring 15 comprises the coil spring, thereby reliably bringing the entire outer peripheral surface of the check spring 15 into contact with the inner peripheral surface of the outer cylindrical body 7, and always stabilizing a force for holding the door D.

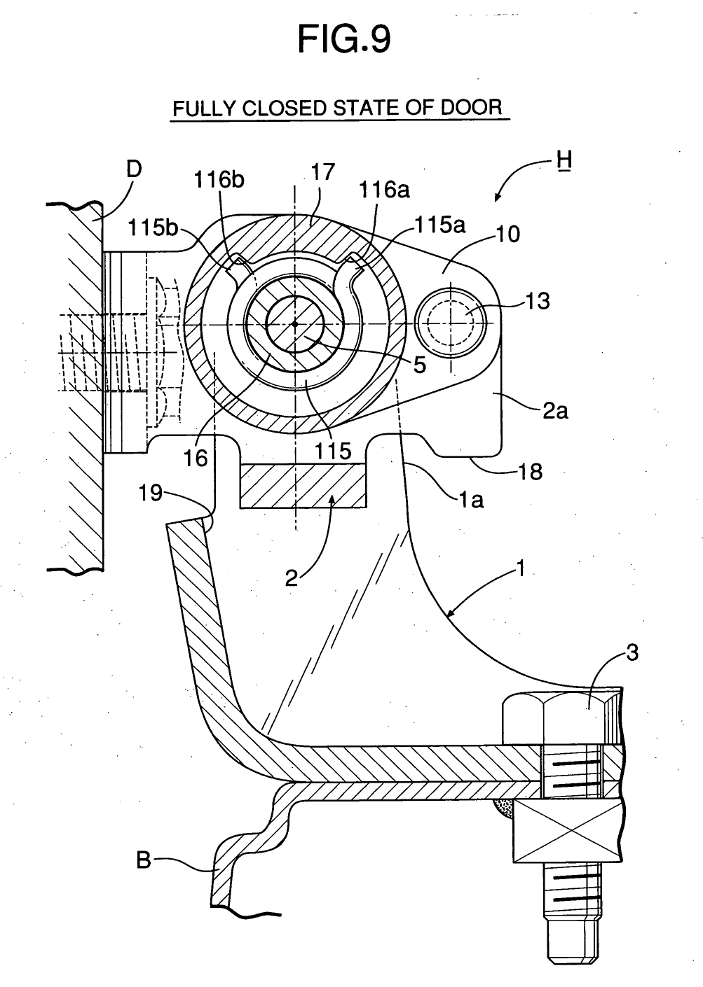

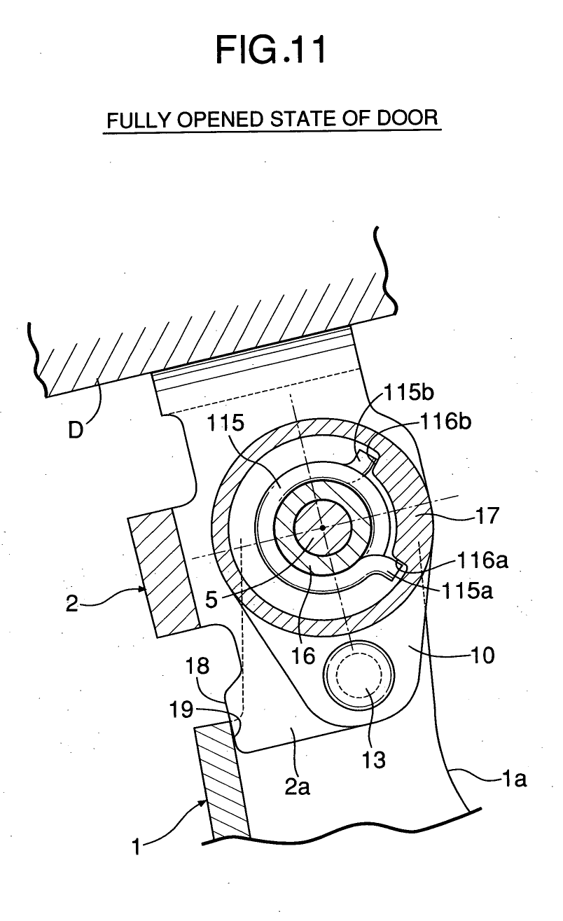

Next, a second embodiment of the present invention shown in FIGS. 9 to 11 will be described.

In the second embodiment, a check spring 115 comprising a coil spring has an inner diameter smaller than an outer diameter of an inner cylindrical body 16 in a free state. This check spring 115 is radially expanded and fitted over an outer periphery of the inner cylindrical body 16, and then the expanding force is released, whereby the check spring 115 comes into contact with an outer peripheral surface of the inner cylindrical body 16 with its own contracting resilient force.

Opposite ends of the check spring 115 have first and second engaging portions 115a and 115b formed by bending wire ends of the spring radially outward. First and second control portions 116a and 116b are formed in an outer periphery of the outer cylindrical body 17 so that they face inner surfaces of the first and second engaging portions 115a and 115b, respectively, with minute clearances therebetween in a circumferential direction of the check spring 115. The other components are the same as those in the first embodiment. Thus, components corresponding to those in the first embodiment in FIGS. 9 to 11 are denoted by the same reference numerals of the first embodiment, and overlapping descriptions will be omitted.

Thus, the check spring 115 arranged in the outer cylindrical body 17 is generally in contact with an inner peripheral surface of the inner cylindrical body 16 with its own contracting resilient force. Thus, a large friction force that resists relative rotation between the inner cylindrical body 16 and the check spring 115 is generated therebetween. The first and second control portions 116a and 116b of the outer cylindrical body 17 face the first and second engaging portions 115a and 115b so as to prevent rotation of the check spring 115.

Thus, for example, as shown in FIGS. 9 to 11, when the door D is at any opening degree position in an unloaded state, the door D can be held at any stop position by the large friction force between the check spring 115 and the inner cylindrical body 16.

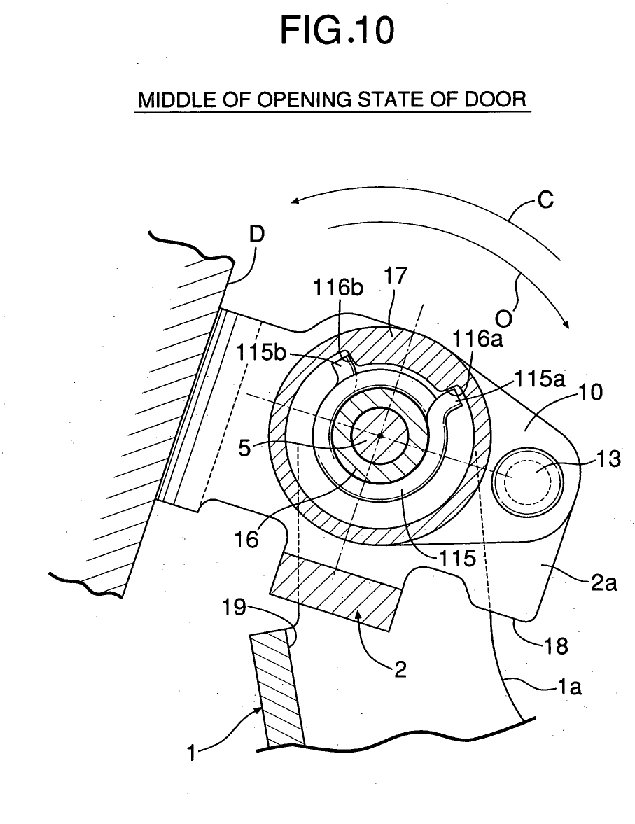

As shown in FIG. 10, for example, if an opening operation force O of a predetermined value or more is applied to the door D held at any intermediate opening degree position, the first control portion 116a of the outer cylindrical body 17 pushes the first engaging portion 115a of the check spring 115 to radially expand the check spring 15 to reduce the friction force between the check spring 115 and the inner cylindrical body 16, whereby the door D can be smoothly opened while causing a slide between the inner cylindrical body 16 and the check spring 115.

If a closing operation force C of a predetermined value or more is applied to the door D, the second control portion 116b of the outer cylindrical body 17 pushes the second engaging portion 115b of the check spring 115 to similarly radially expand the check spring 115 to reduce the friction force between the check spring 115 and the inner cylindrical body 16, whereby the door D can be smoothly closed while causing a slide between the inner cylindrical body 16 and the check spring 115.

As described above, if the door D is rotated in an opening direction or a closing direction to release the opening operation force O or the closing operation force C applied to the door D at any opening degree position, the door D again enters the unloaded state, whereby the door D can be held at any stop position by the large friction force generated between the check spring 115 and the outer cylindrical body 17 as described above. The same advantages as in the first embodiment can be obtained by the second embodiment.

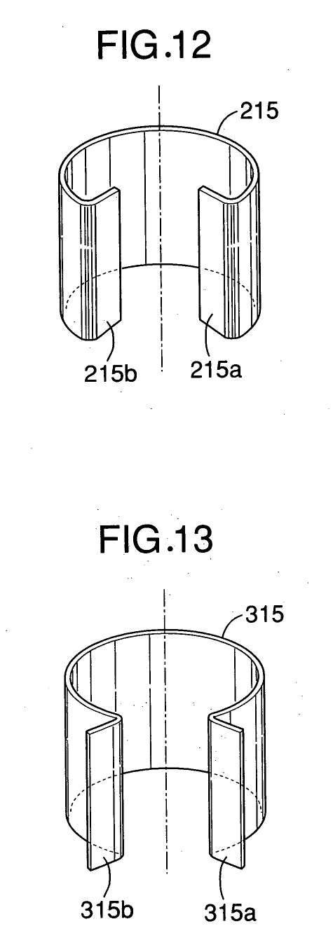

FIG. 12 shows a modification of the check spring 15 in the first embodiment. A check spring 215 in this example is formed by bending a leaf spring into a major arc and bending opposite ends thereof radially inwardly to form first and second engaging portions 215a and 215b. Amounting structure thereof to the outer cylindrical body 7 and the inner cylindrical body 6 as well as a function thereof are the same as those in the first embodiment.

FIG. 13 shows a modification of the check spring 115 in the second embodiment. A check spring 315 in this example is formed by bending a leaf spring into a major arc and bending opposite ends thereof radially outwardly to form first and second engaging portions 315a and 315b. Amounting structure thereof to the outer cylindrical body 17 and the inner cylindrical body 16 as well as a function thereof are the same as those in the second embodiment.

The present invention is not limited to the above embodiments, and various changes in design may be made without departing from the subject matte of the invention. For example, the female bracket 1 may be secured to the door D, and the male bracket 2 may be secured to the body B.

What is claimed is:

1. An automobile door hinge device comprising:
a first bracket secured to one of a body and a door;
a second bracket secured to the other thereof; and
a hinge pin that relatively rotatably connects the brackets to each other,
wherein the device further comprises:
an inner cylindrical body integrally connected to the first bracket and rotatably fitted over an outer periphery of the hinge pin;
an outer cylindrical body integrally connected to the second bracket to surround the inner cylindrical body;
a check spring disposed between the inner cylindrical body and the outer cylindrical body to come into contact with an outer peripheral surface of the inner cylindrical body or an inner peripheral surface of the outer cylindrical body with a resilient force of the check spring;
a first control portion that is provided in one of the inner cylindrical body and the outer cylindrical body to face a first engaging portion at one end of the check spring, and displaces the first engaging portion in a direction releasing the contact of the check spring during relative rotation in one direction of the inner cylindrical body and the outer cylindrical body; and
a second control portion that is provided in said one of the inner cylindrical body and the outer cylindrical body to face a second engaging portion at the other end of the check spring, and displaces the second engaging portion in a direction releasing the contact of the check spring during the relative rotation in the other direction of the inner cylindrical body and the outer cylindrical body.

2. The automobile door hinge device according to claim 1, wherein the check spring is adapted to come into contact with the inner peripheral surface of the outer cylindrical body, and the first and second control portions are provided in the inner cylindrical body.

3. The automobile door hinge device according to claim 1, wherein the check spring is adapted to come into contact with the outer peripheral surface of the inner cylindrical body, and the first and second control portions are provided in the outer cylindrical body.

4. The automobile door hinge device according to claim 1, wherein the check spring comprises a coil spring.

5. The automobile door hinge device according to claim 2, wherein the check spring comprises a coil spring.

6. The automobile door hinge device according to claim 3, wherein the check spring comprises a coil spring.
